(19) United States
(12) Patent Application Publication
(10) Pub. No.: US 2014/0346380 A1
(43) Pub. Date: Nov. 27, 2014

(54) Electrically Operated Valve Assembly

(71) Applicant: Johnson Electric S.A., Murten (CH)

(72) Inventor: Yvan BOURQUI, Corminboeuf (CH)

(73) Assignee: Johnson Electric S.A., Murten (CH)

(21) Appl. No.: 14/284,188

(22) Filed: May 21, 2014

(30) Foreign Application Priority Data
May 21, 2013 (GB) 1309155.8

(51) Int. Cl. F16K 31/04

(52) U.S. Cl. CPC F16K 31/041
USPC 251/129.11

(57) ABSTRACT

An electrically operated valve assembly has a valve element moved by an actuator. The actuator has a motor connected to an output via a gear train. The output is connected to the valve element. The gear train has a gear ratio which is variable depending on the actuation angle of the output shaft. Optionally, a return spring is arranged to resiliently return the output shaft to an initial actuation angle when the motor is not active.

### CROSS REFERENCE TO RELATED APPLICATIONS

This non-provisional patent application claims priority under 35 U.S.C. §119(a) from Patent Application No. GB1309155.8 filed in The United Kingdom on May 21, 2013.

### FIELD OF THE INVENTION

This invention relates to a valve operated by an actuator having a progressive gear.

### BACKGROUND OF THE INVENTION

Valves are used to regulate the flow of a fluid through a pipe, passage or opening. The fluid may be a gas, such as air or a liquid, such as water. Many applications require the valves to be remotely operated or automatically operated depending on set parameters. While some applications require the valve to be either open or closed, others are required to regulate the flow of the fluid through the valve. Control and regulation is conveniently accomplished by means of electromechanical actuators. The actuators turn the valve element to vary the size of the opening for fluid to pass through.

Open loop operation of stepper motor actuators is a reliable state of the art technique. For some applications the position of the valve must be carefully controlled and in case of power failure or in any situation of incorrect valve positioning at shut down, a fail safe mechanism must be integrated in the actuator, to open or close the valve. A return spring can for instance bring the valve element to an initial position (open or closed, whatever is required). In that case, when in operation, the actuator has to work permanently against the spring force plus any additional forces due to the fluid flowing through the valve and impinging on the valve element. Normally that would require an over dimensioned or over powered electromagnetic motor to deliver the required maximum torque at the appropriate valve position under abnormal operating conditions due to the non-constant torque requirements of the valve. It also means higher electric power consumption, which is not in accordance with an efficient environmentally-friendly or “green” system.

Hence there is a desire for an actuator for a valve operating system, in which the output of the actuator is more closely matched to the torque required to operate the valve. The present invention solves this problem by means of a progressive gear which compensates for the variable torque requirements.

Progressive or variable gears have been known for a long time. A comprehensive description of a progressive gear can be found in U.S. Pat. No. 2,061,322 or U.S. Pat. No. 8,196,487. In automotive applications progressive gears frequently appear in steering systems.

### SUMMARY OF THE INVENTION

Accordingly, in one aspect thereof, the present invention provides an electrically operated valve assembly, comprising: a valve body having a passage for fluid to flow through; a valve element movable with respect to the valve body for varying the flow of the fluid through the passage; an actuator arranged to move the valve element, the actuator comprising: a motor having a motor shaft; an output, including an output shaft and a connection for connecting to the valve element; and a gear train connecting the motor shaft to the output shaft, wherein the gear train has a gear ratio that is variable depending on the actuation angle of the output shaft.

Preferably, the gear train comprises at least one progressive gear.

Preferably, the progressive gear comprises a first spiral gear wheel and a second spiral gear wheel in mesh with the first spiral gear wheel.

Preferably, the second spiral gear wheel is fixed to the output shaft.

Preferably, the first spiral gear wheel is connected to the motor shaft by at least one spur gear.

Preferably, the first and second spiral gear wheels have logarithmic pitch paths.

Preferably, a return spring is arranged to resiliently return the output shaft to an initial actuation angle when the motor is not active.

Preferably, the return spring is a coil spring disposed about the output shaft with one end fixed to the second spiral gear wheel and a second end fixed to a part supporting the output shaft.

Preferably, the motor is a stepper motor and is connected to a PCB having a control circuit for controlling the motor in response to control signals.

Preferably, the valve element is displaceable between a first position where the valve is essentially closed and a second position where the valve is essentially fully open.

Preferably, the valve element is positionable at positions between the first and second positions.

Preferably, the valve element is a butterfly valve element.

Preferably, the valve is a throttle valve of a fuel supply system for an internal combustion engine.

Alternatively, the valve element is a ball valve element, rotatable about a fixed axis.

Optionally, the valve is a water supply valve.

Optionally, the valve element is a spindle valve element.

Alternatively, the valve is a liquid control valve of a heat exchanger.

Optionally, the valve is a control valve of a heat exchange system for an internal combustion engine.

The present invention allows the construction of an electrically operated valve for gas or liquids having an actuator with an output which more closely follows the operating requirements of the valve, thus allowing a smaller, more efficient actuator for this application. Certain embodiments of the invention allow for the construction of a fail safe actuator which can be used in an open loop operation. This eliminates the need for a sensor system to detect the actual position of the valve element, as needed by prior art actuators, reducing complexity and cost.

Certain embodiments of the invention are applicable to the butterfly valve used in a carburetor or fuel supply system of an internal combustion engine while other embodiments are applicable to water valves, in particular to valves controlling the flow of cooling water in a heat exchanger system, such as the engine cooling system of a vehicle.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 shows a torque curve for a typical prior art actuator having a constant torque output with respect to actuator output position;

FIG. 2 illustrates a typical non-linear torque curve for opening a butterfly valve;

FIG. 3 is a view of the assembled actuator according to the preferred embodiment with a cover removed;

FIG. 4 illustrates a gear train arrangement of the actuator of the preferred embodiment;

FIG. 5 illustrates a butterfly valve;

FIG. 6 is a schematic illustration of the operation of a butterfly valve;

FIG. 7 illustrates an example of a two-way valve with an actuator;

FIG. 8 is a schematic representation showing the operation of a linear globe valve;

FIG. 9 is a schematic representation showing the operation of a piston valve;

FIG. 10 is a schematic representation showing the operation of a gate valve;

FIG. 11 is a schematic representation showing the operation of a wedge gate valve;

FIG. 12 is a schematic representation showing the operation of a diaphragm valve;

FIG. 13 is a schematic representation showing the operation of a pinch valve;

FIG. 14 is a schematic representation showing the operation of a rotary ball or plug valve;

FIG. 15 is a schematic representation showing the operation of a rotary globe valve;

FIG. 16 is a schematic representation showing the operation of a rotary disc valve; and

FIG. 17 is a partially sectioned schematic view of a rotary valve assembly.

### DETAILED DESCRIPTION OF THE PREFERRED EMBODIMENTS

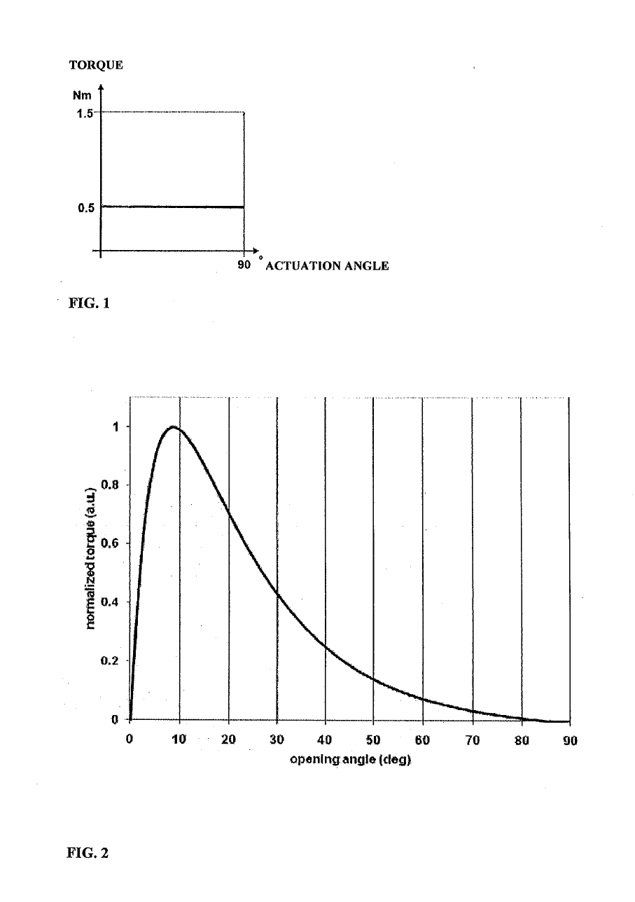

FIG. 1 shows a torque v position curve for a system having a linear relationship between the position of the output of the actuator (actuation angle) and the required torque. This is the assumed relationship used in the design of prior art actuators for valves. FIG. 2 shows a similar graph for a system having a non-linear relationship. This curve a typical torque curve showing the torque required to open a butterfly valve controlling the flow of a liquid. This is typical of fluid valves where the force to open the valve is high initially but then decreases as the valve opens. In addition to a mostly constant mechanical friction offset, the actuator has to overcome torque applied to the valve element by the fluid, which is greatest at a position close to the fully closed position. This curve is similar to torque curves for many rotary and linear fluid valves and is provided to illustrate the non-constant torque requirements of fluid valves. Of course, the actual force applied to the valve elements of the various valves, varies according to the design of the valve as well as the fluid involves and the fluid pressure and flow rate. For some valves greater torque is required to close the valve whereas for others greater torque is required to open the valve. However, the torque curve is not constant.

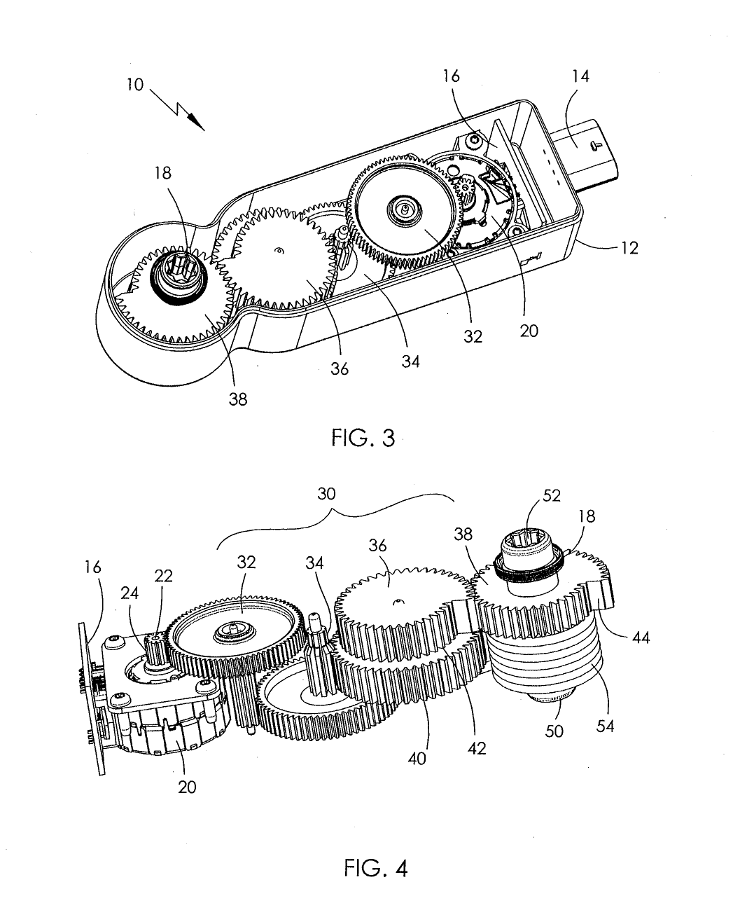

FIG. 3 illustrates the preferred actuator, in assembled form, with a cover removed to show the insides. The actuator 10 has a casing 12 with a lid (not shown), accommodating a stepper motor 20, an output 18 and a gear train 30 connecting the motor to the output. An electrical socket 14 provides connection for power and signal lines for operating the motor. A PCB 16 (printed circuit board) is also provided for electronics for controlling the motor based on commands via the signal line. The PCB may include LIN-Bus electronics for communication with a system management computer.

The gear train 30 is more clearly shown in FIG. 4. The gear train connects the shaft 22 of the motor to the output 18 of the actuator. The motor of the preferred embodiment is a stepper motor 20 and is shown in FIG. 4 connected to the PCB 16. The output 18 of the actuator, in the preferred embodiment, is a shaft 50 having a star shaped socket 52 for receiving an end of a spigot or drive shaft of the valve mechanism for changing the angle or position of the valve element.

The gear train 30 comprises a first spur gear 32 in mesh with a cog 24 fitted to the motor shaft 22, a second spur gear 34 in mesh with the first spur gear, a first progressive gear 36 and a second progressive gear 38. The first progressive gear is a combination of a regular spur wheel 40 with a first spiral gear wheel 42. The spur wheel 40 is in mesh with the second spur gear 34 and the first spiral gear wheel 42 is in mesh with the second progressive gear 38. The second progressive gear comprises a second spiral gear wheel 44 fixed to the output shaft of the actuator. The second spiral gear wheel 44 is in mesh with the first spiral gear wheel 42.

A return spring 54 is attached to the output shaft 50, preferably via the second spiral gear wheel 44, to return the output shaft to a home position or initial actuation angle when the motor is turned off, back-driving the motor through the gear train. The return spring 54 is shown as a spiral or coil spring disposed about the output shaft 50 with one end fixed to the shaft by way of the second spiral gear wheel 44 and the other end fixed to the casing 12. Thus in use, as the output shaft is moved from the home position the spring is wound up (or down) creating a resilient restoring force urging the output shaft to return to the home position. The motor 20 is required to drive the output shaft against this restoring force. The motor is also required to drive or hold the output shaft at a desired actuation angle against external forces such as the force applied to the valve element by fluid pressure especially when the fluid has a high flow rate.

The progressive gear ratio is formed by the interaction of the two spiral gear wheels. Preferably, the spiral gear wheels 42, 44 are logarithmic gears meaning that their pitch line follows a logarithmic spiral path. The progressive gear ratio changes the maximum output torque of the actuator at different actuation angles. This allows the motor to be physically smaller while still providing the required maximum torque output through the higher gear ratio in the high torque require region while providing fast response time in the lower torque required regions due to the lower gear ratio in that region. Thus the output torque of the actuator is more closely matched with the load requirements and the motor is not over powered for most of the actuation angles just to satisfy the torque requirements at a particular actuation angle.

A progressive gear may comprise at least one wheel with varying radius as a function of angle, delivering variable torque and variable tangential speed. In order to construct a gear train where the wheels have fixed axes, one advantageous configuration comprises two logarithmically spiral wheels which satisfy the following conditions:

constant distance between the two wheel axes;

continuous contact of the gear wheels during one full cycle;

the radius increases exponentially with the wheel angle r(φ)=a·exp(k·φ); and

the ratio of input and output wheel angle is logarithmic (as is also true for the torque).

Appropriate dimensioning of the spiral gear wheel parameters allows for compensation of the variable torque. By use of the progressive gear we can significantly reduce the motor size (lower price and weight) and diminish the average power consumption.

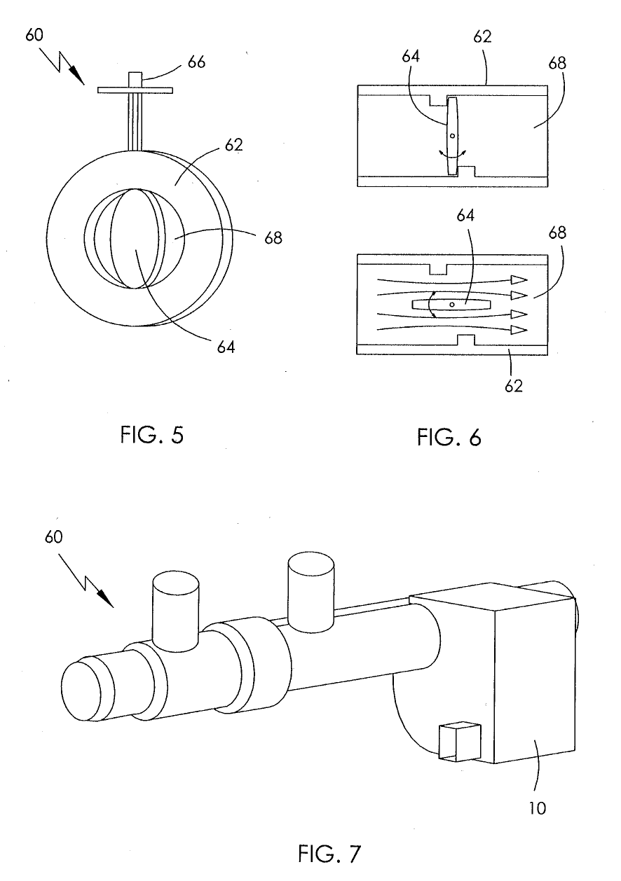

FIG. 5 illustrates a butterfly valve 60 to which can be fitted an actuator according to the present invention. The valve 60 has a valve body 62 having a through passage 68 and a valve element 64 which is movable to open or close the passage. The valve element is attached to a spindle 66 which is rotated by the actuator. In this embodiment the valve element is a butterfly element fixed to the spindle and disposed within the passage. As shown in the schematic illustrations of FIG. 6, the valve element 64 is rotated through 90°, between a first position in which the valve element extends across the passage 68 and closes or completely blocks the passage, to a second position, known as the open position, in which the valve extends in the direction of the passage and offers minimal obstruction to the flow of fluid through the passage. As can be appreciated from FIG. 6, as the valve begins to open, the pressure of the fluid on the valve element is relatively high, whereas when the valve is nearly fully open the pressure of the fluid on the valve element is relatively low.

FIG. 7 illustrates a two-way valve 60, wherein the valve element is moved linearly within the valve body to open or close the valve. In this embodiment, the valve has one inlet and two outlets. The valve element slides within the passage through the valve body. In a first position, the valve element blocks or closes the inlet. In a second position, the valve element opens the first outlet and blocks the second outlet. In a third position, where the valve element is located between the inlet and the first outlet, the second outlet is opened and the first outlet is blocked. As can be understood, closing of the valve requires greater torque as the pressure of the fluid flowing through the valve opposes the closing of the valve. However, once closed, the valve is relatively easy to open.

FIGS. 8 to 13 illustrate other valve types in which the valve element is moved linearly to effect opening and closing of the valve. The images are schematic representations illustrating the operating principles of the valve type. FIG. 8 illustrates a linear globe valve in which the valve element is moved linearly up or down to open or close the passage through the valve body. Usually linear motion is achieved by a screw connection between the spindle and the valve element. The valve element is slidable supported but prevented from turning. Thus as the spindle is turned by the actuator, the valve element will move up or down along the spindle. In this valve type the valve element seals against a seat formed within the passage to close the valve.

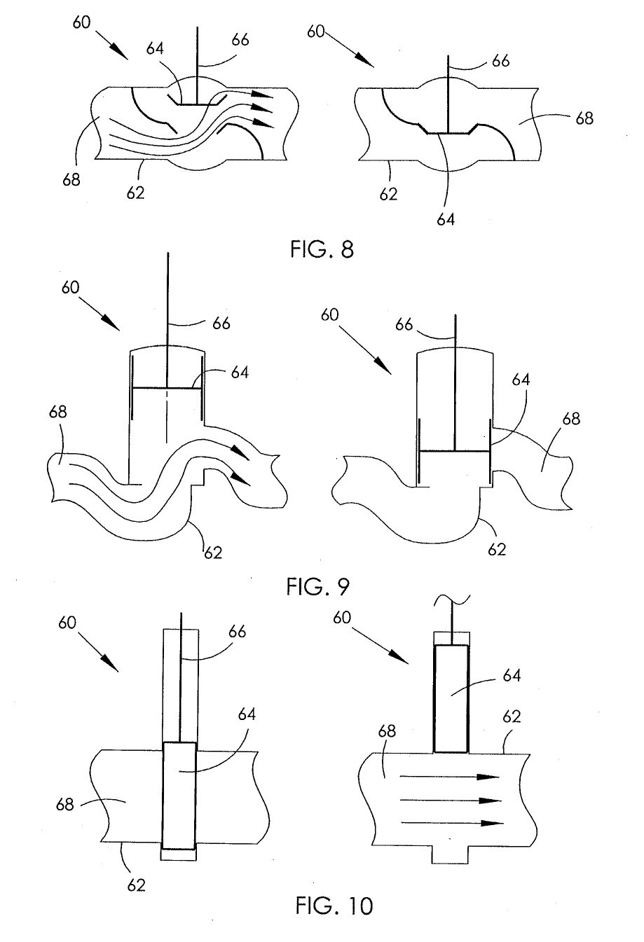

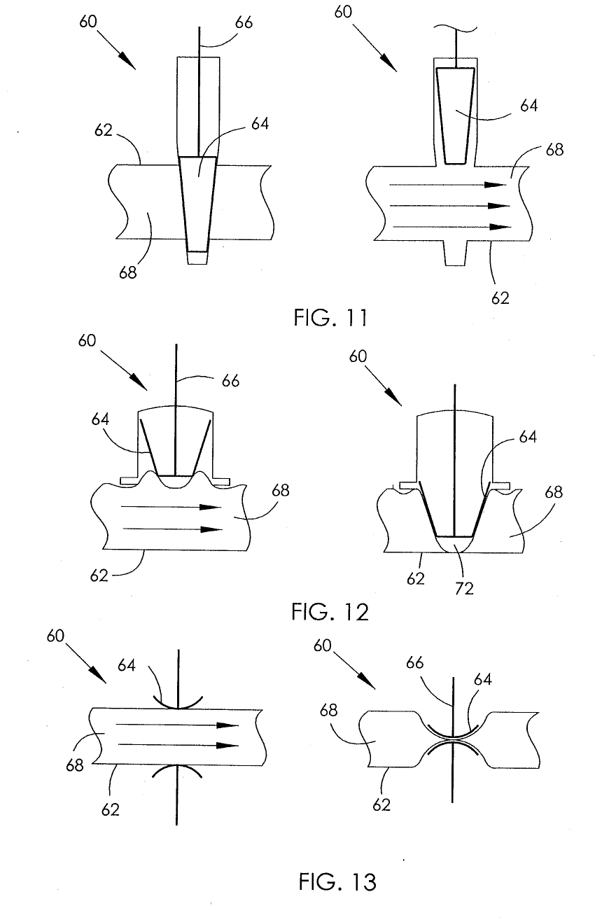

FIG. 9 illustrates a piston valve 60 in which the valve element 64 is a piston which moves up and down to open or close the passage 68. FIG. 10 illustrates a gate valve having a parallel gate valve element 64 which is moved up or down to open or close the passage 68. FIG. 11 is a gate valve with a wedge shaped gate. This operates in a similar way to the valve of FIG. 10. FIG. 12 illustrates a diaphragm valve. The valve element includes a rubber diaphragm 72 which is move up and down to open and close the passage. The rubber diaphragm provides a reliable seal as desired in certain applications, such as for gas lines. FIG. 13 illustrates a pinch valve in which the valve element compresses a flexible portion of the passage to squeeze off the flow of fluid through the valve.

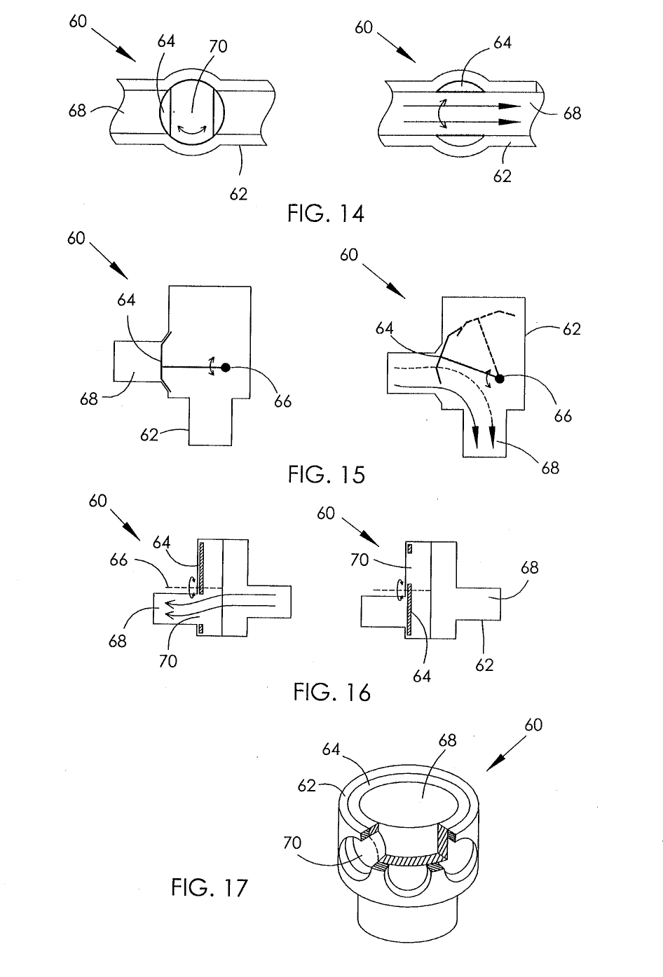

FIGS. 14 to 17 illustrate other valve types in which the valve element is moved in a rotary manner, i.e. rotated, to effect opening and closing of the valve. The images are schematic representations illustrating the operating principles of the valve type. FIG. 14 illustrates the principle of operation of a ball valve or a plug valve 60, in which the valve element 64 has a through hole 70 which, in the open position, is aligned with the through passage 68 of the valve body 62. To restrict flow through the valve and to close the valve, the valve element is rotated so the hole 70 is not aligned with the passage 68 and in the closed position the valve element seals the through passage to prevent the flow of fluid. In a ball valve the valve element is spherical. In a plug valve the valve element is cylindrical or frusto-conical.

FIG. 15 illustrates the operating principles of a rotary globe valve 60 in which the valve element 64 is rotated between an open position and a closed position in which the valve element seals or closes the through passage 68 of the valve body 62. The valve element 64 is attached to the spindle 66 so as to rotate with the spindle as the spindle is rotated by the actuator. FIG. 16 illustrates a disc valve 60 in which a disc with a through hole 70 is rotated from an open position in which the through hole aligns with the through passage 68 and a closed position in which the through hole 70 does not overlap the through passage 68 and the passage is sealed by the disc. FIG. 17 illustrates a rotary valve 60. The valve is shown in partial cutaway form. The valve body 62 has a cylindrical form and the valve element 64 has an annular or hollow cylindrical form disposed inside the valve body within and forming a part of the through passage 68. In this example, the valve has a single inlet (located at the bottom) and a number of outlets (three) formed in the cylindrical wall of the valve body. A hole 70 in the wall of the valve element 64 is rotated to align with a selected outlet, while at the same time the body of the valve element 64 seals the other outlets.

In use the actuator is coupled to the valve to electrically operate or move the valve element between the closed position and the fully open position. The progressive gear used in the gear box of the actuator is arranged and configured to match with the torque requirement of the valve, thus allowing the motor of the actuator to be sized appropriately for the application. Thus the power consumed by the valve can be reduced and the physical size and weight of the actuator can be reduced resulting in a small, lighter valve assembly.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. An electrically operated valve assembly, comprising:
a valve body having a passage for fluid to flow through;
a valve element movable with respect to the valve body for varying the flow of the fluid through the passage;
an actuator arranged to move the valve element, the actuator comprising:
a motor having a motor shaft;
an output, including an output shaft and a connection for connecting to the valve element; and
a gear train connecting the motor shaft to the output shaft,
characterized in that the gear train has a gear ratio that is variable depending on the actuation angle of the output shaft.

2. The valve assembly of claim 1, wherein the gear train comprises at least one progressive gear.

3. The valve assembly of claim 2, wherein the progressive gear comprises a first spiral gear wheel and a second spiral gear wheel in mesh with the first spiral gear wheel.

4. The valve assembly of claim 3, wherein the second spiral gear wheel is fixed to the output shaft.

5. The valve assembly of claim 3, wherein the first spiral gear wheel is connected to the motor shaft by at least one spur gear.

6. The valve assembly of claim 3, wherein the first and second spiral gear wheels have logarithmic pitch paths.

7. The valve assembly of claim 1, further comprising a return spring arranged to resiliently return the output shaft to an initial actuation angle when the motor is not active.

8. The valve assembly of claim 7, wherein the return spring is a coil spring disposed about the output shaft with one end fixed to the second spiral gear wheel and a second end fixed to a part supporting the output shaft.

9. The valve assembly of claim 1, wherein the motor is a stepper motor and is connected to a PCB having a control circuit for controlling the motor in response to control signals.

10. The valve assembly of claim 1, wherein the valve element is displaceable between a first position where the valve is essentially closed and a second position where the valve is essentially fully open.

11. The valve assembly of claim 10, wherein the valve element is positionable at positions between the first and second positions.

12. The valve assembly of claim 1, wherein the valve element is a butterfly valve element.

13. The valve assembly of claim 12, wherein the valve is a throttle valve of a fuel supply system for an internal combustion engine.

14. The valve assembly of claim 1, wherein the valve element is a ball valve element, rotatable about a fixed axis.

15. The valve assembly of claim 14, wherein the valve is a water supply valve.

16. The valve assembly of claim 1, wherein the valve element is a spindle valve element.

17. The valve assembly of claim 16, wherein the valve is a liquid control valve of a heat exchanger.

18. The valve assembly of claim 16, wherein the valve is a control valve of a heat exchange system for an internal combustion engine.
